(19) United States
(12) Patent Application Publication
(10) Pub. No.: US 2009/0308702 A1
(43) Pub. Date: Dec. 17, 2009

(54) Disc brake cover

(76) Inventors: Hidemi Ichinose, Suzuka-Shi (JP); Toshihiro Nagao, Suzuka-Shi (JP)

Correspondence Address: BIRCH STEWART KOLASCH & BIRCH, PO BOX 747, FALLS CHURCH, VA, 22040-0747, US

(21) Appl. No.: 11/919,287

(22) PCT Filed: Apr. 25, 2006
(86) PCT No.: PCT/JP2006/309130

§ 371 Date: Nov. 30, 2007

(30) Foreign Application Priority Data
Apr. 27, 2005 (JP) 2005-130090

(51) Int. Cl. F16D 65/00

(52) U.S. Cl. 188/218 A

(57) ABSTRACT

A disc brake cover (40) includes a disc portion (41) configured to cover a front side surface and an outer peripheral surface of a brake disc (12) of a disc brake (11), and a caliper portion (42) configured to cover the brake caliper (14) including recessed portions (31, 32, 34) formed on a front side thereof. The caliper portion (42)bas protrusions (95, 96) configured to fit with the recessed portions to thereby attach the disc brake cover to the disc brake with the disc portion located close to the brake disc. The disc brake cover further includes a reinforcement flange (43) extending continuously along outer peripheral edges of the disc portion and the caliper portion.

### TECHNICAL FIELD

The present invention relates to an improvement in a disc brake cover removably attachable to a disc brake for temporarily protecting a brake disc against rusting or corrosion during storage or transportation to a final destination of a finished vehicle.

### BACKGROUND ART

Removable antirust disc brake covers of the type concerned are known heretofore as disclosed, for example, in Japanese Utility Model Laid-open Publication (JP-UM-A) No. 7-15401 and Japanese Patent Laid-open Publication (JP-A) No. 11-51096.

As shown in FIG. 8 hereof, the brake disc cover 101 disclosed in JP-UM 7-15401A is disposed between a disc portion 103 of a wheel 102 and a wheel cap 105 and configured to close a plurality of ventilating holes 104 formed in the disc portion 103 of the wheel 102. The wheel 102 is connected to a wheel hub 106 with a brake rotor or disc 107 disposed therebetween. By thus closing the ventilating holes 104 with the brake disc cover 101 from the outside of the wheel 102, it is almost possible to prevent rain water from splaying onto the brake disc 107 from the outside of the wheel 102.

However, since the disc brake cover 101 is located outside the wheel 102, there is a large space defined between the brake disc 107 and the disc brake cover 101. This arrangement allows rain water to first splash into the wheel 102 from an inner side thereof and then adhere to an outer side surface of the brake disc 107, leading to rusting or corrosion of the brake disc 102. Thus, the disc brake cover 101 can only offer insufficient anticorrosion effect to the disc brake.

Description will be next made to the disc brake cover disclosed in JP 11-51096A with reference to FIG. 9. As shown in FIG. 9, the disc brake cover 111 is removably attached to the outer peripheral edge of a dust cover 113 and extends to cover an outer side surface of a brake rotor or disc 114 except a portion thereof where a caliper is disposed. Thus, the disc brake cover 111 is disposed between the brake disc 114 and a disc portion 116 of a wheel 115. The disc brake cover 111 has a generally cup-shaped configuration including a cylindrical sidewall connected at its outer end to the outer peripheral edge of the dust cover 113 and a bottom wall facing the outer side surface of the brake disc 114.

With this arrangement, however, since the bottom wall of the cup-shaped disc brake cover 111 is located relatively far distant from the outer side surface of the brake disc 114, the disc brake cover 111 also involves the same problem (insufficient anticorrosion effect) as discussed above with reference to the brake disc cover 101 shown in FIG. 8.

Furthermore, for attachment to the dust cover 113, the disc brake cove 111 is provided with a plurality of circumferentially spaced radial protrusions (not shown) formed on an inner surface of the outer sidewall end and slits (not shown) formed in the respective protrusions for interlocking engagement with the outer peripheral edge of the dust cover 113. The thus formed disc brake cover 111 is complicated in configuration and requires an expensive molding die when it is to be produced by molding. Additionally, in order to provide reliable interlocking engagement between the slit radial protrusions of the disc brake cover 111 and the outer peripheral edge of the dust cover 113, the outer end of the sidewall of the disc brake cover 111 should be forced against the outer peripheral edge of the dust cover 113 with forces or pressures uniformly distributed in a circumferential direction of the disc brake cover 111. Such a disc brake cover attachment process requires a dexterous human operator. The thus provided interlocking engagement hinders smooth muscular-effort-free detachment of the disc brake cover 111 from the dust cover 113.

### DISCLOSURE OF THE INVENTION

The present invention seeks to provide a disc brake cover which is capable of offering a sufficient anticorrosion effect to the disc brake, is simple in construction and can be manufactured at a relatively low cost, and can be easily attached to and detached from the disc brake without requiring undue muscular efforts.

According to one aspect of the present invention, there is provided a disc brake cover for covering a brake disc and a brake caliper of a disc brake collectively from a front side thereof facing in a lateral outward direction of a vehicle body, the brake caliper having a pair of recessed portions disposed on the front side thereof and defined between a caliper bracket and a caliper body of the brake caliper at portions located adjacent to a pair of support arms of the caliper bracket disposed on opposite sides of the caliper body and supporting the caliper body so that the caliper body is movable relative to the caliper bracket, the disc brake cover comprising:

a disc portion configured to cover a side surface and an outer peripheral surface of the brake disc;

a caliper portion integral with the disc portion and configured to cover the brake caliper including the recessed portions thereof, the caliper portion having a pair of protrusions configured to fit with the pair of recessed portions, respectively, of the brake caliper to thereby attach the disc brake cover to the disc brake with the disc portion located close to the brake disc; and

a reinforcement flange extending continuously along an outer peripheral edge of the disc portion and an outer peripheral edge of the caliper portion.

With this arrangement, since the disc brake cover covers the brake disc and the brake caliper collectively from the front side of the disc brake with the disc portion located close to the brake disc, it is possible to effectively prevent rain water from entering into a space or gap between the disc portion and the brake disc. Thus, the disc brake cover can offer a sufficient anti-corrosion effect to the disc brake during storage or transportation to a final destination of a finished vehicle in which the disc brake is incorporated.

Furthermore, for attachment to the disc brake, the disc brake cover requires only one pair of protrusions configured to fit with the first recessed portions of the brake caliper. The disc brake cover is, therefore, relatively simple in construction and can be manufactured at a relatively low cost by using an inexpensive molding die.

Preferably, the caliper portion further has a second protrusion disposed centrally between the pair of protrusions and engageable with a front surface of the caliper body to keep the disc portion in a position spaced from the side surface of the brake disc by a predetermined distance. It is preferable that the second protrusion is configured to fit with a second recessed portion formed in the front surface of the caliper body and located centrally between the pair of recessed portions.

Preferably, each of the disc portion and the caliper portion has a plurality of weak portions arranged in a predetermined pattern to allow the disc brake cover to become fractured when subjected to an external force tending to remove the disc brake cover from the disc brake. The weak portions thus provided insure easy removal of the disc brake cover from the disc brake. The weak portions may be formed by perforated lines.

The disc brake cover may further have a pull tab integral with the reinforcement flange and projecting in a radial outward direction from the reinforcing flange for gripping by a human operator. Preferably, the pull tab is disposed adjacent to one of the weak portions of at least one of the disc portion and the caliper portion. When the disc brake cover is to be removed, the pull tab is pulled by the human grips in a direction tending to turn or rotate the disc brake cover about a wheel axle while the protrusions remain interlocked with the corresponding. recessed portions. Continued pulling of the pull tab causes rupturing of the disc brake cover, which begins at the perforated line (weak portion) disposed adjacent to the pull tab. The rupturing continues to occur in succession at adjacent perforated lines (weak portions) arranged in a direction aligned the direction of a pulling force acting on the pull tab. The disc brake cover can thus be removed from the disc brake by merely pulling the pull tab in an appropriate direction. To ensure that the disc brake cover 40 can be removed with small muscular efforts, the pull tab is preferably located at a position spaced far distant from the protrusions.

### BRIEF DESCRIPTION OF THE DRAWINGS

FIG. 1 is a perspective of a disc brake to which a disc brake cover according to the invention is attached;

FIG. 2 is a front elevational view of a disc brake cover according to the invention as it is attached to the disc brake with a wheel removed for clarity;

FIG. 3 is a side view of the brake disc cover with the wheel with shown in cross section for clarity

FIG. 4 is a cross-sectional view taken along line 4-4 of FIG. 2;

FIG. 5 is a front elevational view of a brake caliper of the disc brake on which the disc brake cover is retained;

FIG. 6 is a side view of the brake caliper;

FIG. 7A is a schematic plan view of the disc brake including the brake caliper and the brake disc;

FIG. 7B is a cross-sectional view of the disc brake cover;

FIG. 7C is a plan view, with parts in cross section, of the disc brake cover as it is attached to the disc brake;

FIG. 8 is a schematic cross-sectional view showing a conventional disc brake cover; and

FIG. 9 is a view similar to FIG. 8, but showing another conventional disc brake cover.

### BEST MODE FOR CARRYING OUT THE INVENTION

One preferred embodiment of the present invention will be described below in greater detail with reference to the accompanying sheets of drawings.

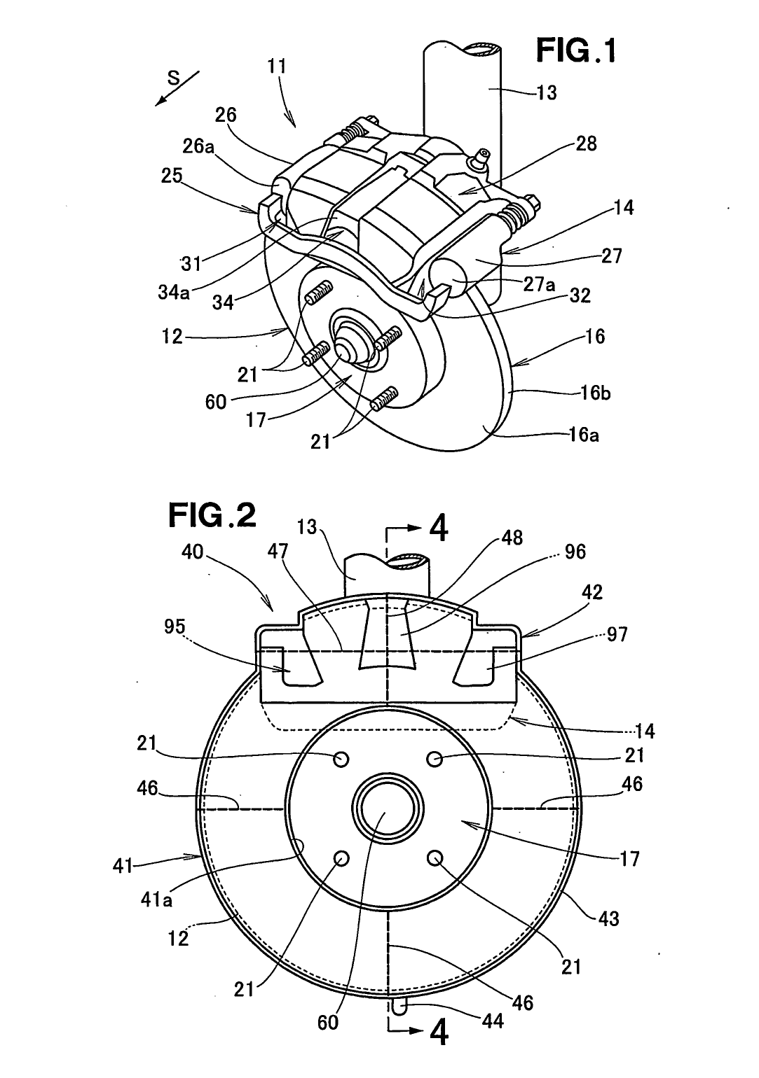

FIG. 1 shows in perspective a disc brake 11 to which a disc brake cover according to the invention is attached. The disc brake 11 generally comprises a brake rotor or disc 12 rotatably mounted on a wheel axle 60 of a motor vehicle, and a brake caliper 14 mounted to a strut 13 of a suspension unit for slowing down or stopping rotation of the brake disc 12.

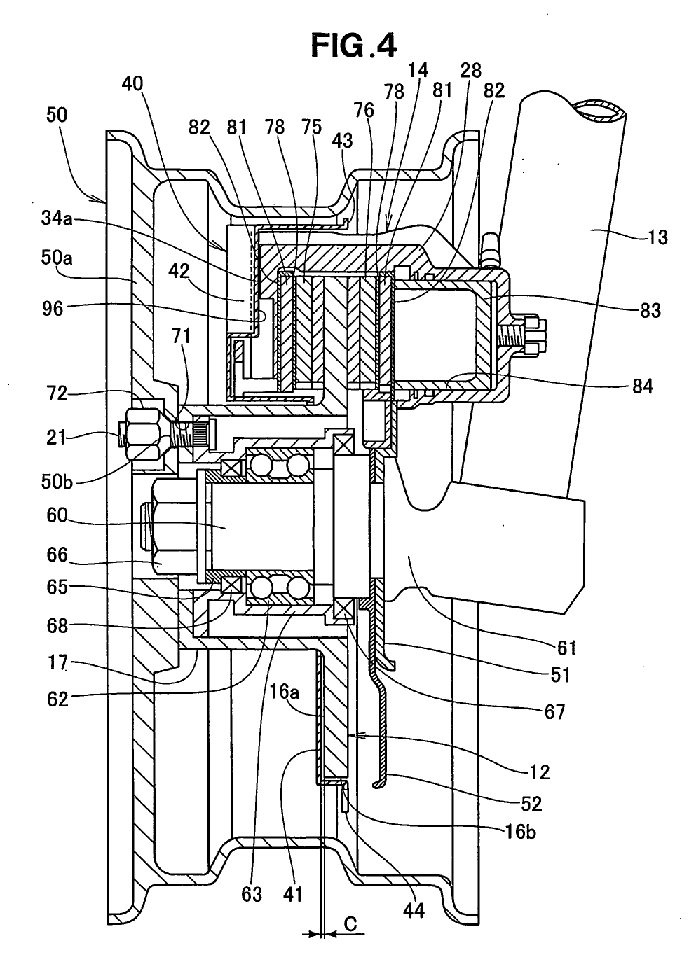

The brake disc 12 includes a disc part 16 provided for friction engagement with brake pads of the brake caliper 14 and a central boss 17 projecting from an inner peripheral edge of the disc part 16 in an axial direction of the brake disc 12 for connection of the brake disc 12 to a wheel hub 63 (FIG. 4) via wheel studs 21. The disc part 16 has an outer or front side surface 16a facing in a lateral outward direction of a vehicle body (indicated by the arrow S shown in FIG. 1) and an outer peripheral surface 16b.

The brake caliper 14 includes a caliper bracket 25 attached to the vehicle body, and a caliper body 28 movably mounted on the caliper bracket 25 via a pair of support arms 26, 27 and movable relative to the caliper bracket 25 in a direction parallel to an axis of the wheel axle 60. The support arms 26, 27 are formed as a part of the caliper bracket 25 and disposed on opposite sides of the caliper body 28.

The brake caliper 14 has a pair of recessed portions 31 and 32 disposed on a front side thereof facing in the lateral outward direction of the vehicle body (as indicated by the arrow S shown in FIG. 1) and defined between the caliper bracket 25 and the caliper body 28 at portions located adjacent to the support arms 26, 27. The first recessed portions 31, 32 are used for a purpose described below. The brake caliper 14 also has a second recessed portion 34 formed in a front surface 34a of the caliper body 28 and disposed centrally between the pair of first recessed portions 31, 32. The second recessed portion 34 is used for a purpose described later on. The front surface 34a faces in the lateral outward direction of the vehicle body as indicated by the arrow S shown in FIG. 1.

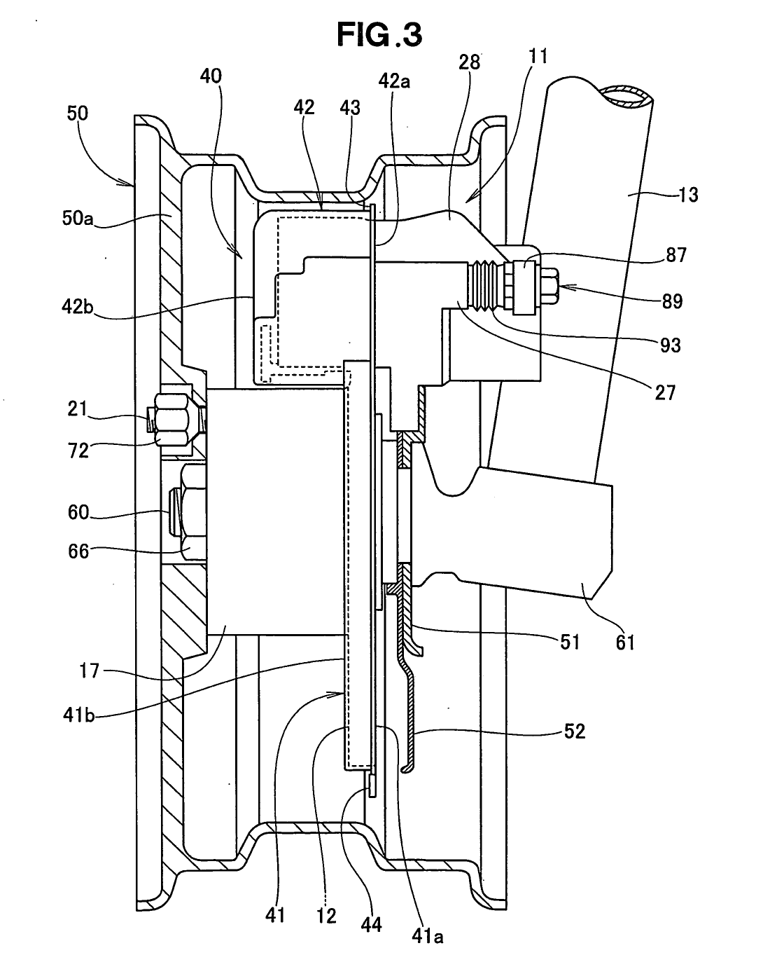

FIGS. 2 and 3 show a disc brake cover 40 according to the invention as it is attached to the disc brake 11 of FIG. 1. As shown in FIGS. 2 and 3, the disc brake cover 40 covers the brake disc 12 and the brake caliper 14 of the disc brake 11 collectively from the front side of the disc brake 11. The disc brake cover 40 includes a disc portion 41 configured to cover the side surface 16a and the outer peripheral surface 16b of the brake disc 12, and a caliper portion 42 integral with the disc portion 41 and configured to cover the brake caliper 14 including the first recessed portions 31, 32 (FIG. 1) and the second recessed portion 34 (FIG. 1). The disc portion 41 has a generally ring-like configuration including a central hole 41a (FIG. 2) through which the central boss 17 of the disc brake 12 projects. The disc brake cover 40 also includes an annular reinforcement flange 43 extending continuously along an outer peripheral edge of the disc portion 41 and an outer peripheral edge of the caliper portion 42. With the reinforcement flange 43, the disc brake cover 40 has a self-supported structure that can retain its original shape even when the disc brake cover 40 is attached to the disc brake 11 in a manner as described below.

As shown in FIG. 2, a front side of the disc brake cover 40 is recessed to form a pair of laterally spaced first protrusions 95 and 97 projecting on a back side of the disc brake cover 40, and a second protrusion 96 projecting on the back side of the disc brake cover 40 and disposed centrally between the first protrusions 95, 97. The first protrusions 95, 97 are configured to fit with the first recessed portions 31, 32 (FIG. 1), respectively, of the brake caliper 14 to thereby attach the disc brake cover 40 to the disc brake 11 (FIG. 1) with the disc portion 41 located close to the brake disc 12. The second protrusion 96 is configured to fit with the second recessed portion 34 (FIG. 1) of the brake caliper 11. The second protrusion 96 is engageable with the front surface 34a (FIG. 1) of the caliper body 28 to keep the disc portion 41 in a position spaced from the side surface 16a (FIG. 1) of the brake disc 12 by a predetermined distance C (FIG. 4) when the disc brake cover 40 and the disc brake 11 are in an assembled state. The degree of the fitting engagement between the protrusions 95, 96, 97 and the mating recessed portions 31, 34, 32 may include a force fit, an interference fit and a friction fit.

As shown in FIG. 2, the disc brake cover 40 has a plurality of perforated lines 46, 47, 48 provided as weak portions to allow the disc brake cover 40 to become fractured when the disc brake cover 40 is subjected to an external force tending to remove the disc brake cover 40 from the disc brake 11. The perforated lines (weak portions) 46-48 are arranged in a pre-determined pattern. More particularly, the perforated lines 46-48 comprise first perforated lines 46 (three in the illustrated embodiment) formed in the disc portion 41 radially across the disc portion 41 and spaced at regular intervals in the circumferential direction of the disc portion 41, a single second perforated line 47 formed in the caliper portion 41 and extending horizontally across the caliper portion 41, and a single third perforated line 48 formed in the caliper portion 42 and extending vertically across the caliper portion 42. The disc brake cover 40 has a pull tab 44 formed integrally with the reinforcement flange 43 and projecting in a radial outward direction from the reinforcement flange 43 for gripping by a human operator when the disc brake cover 40 is to be removed from the disc brake 11. In the illustrated embodiment, the pull tab 44 is disposed adjacent to one of the first perforated lines (weak portions) 46 formed in the disc portion 41. The first perforated line 46 is aligned with the third perforated line 48 and disposed on an opposite side of the third perforated line 48 with respect to the center of the wheel axle 60. The pull tab 44 disposed adjacent to the first perforated line 46 is located at a position spaced far distant from a point of interlocking engagement formed between the protrusions 95, 96 and 97 and the mating ones of the recessed portions 31, 34, 32.

The disc brake cover 40 in the illustrated embodiment is molded from a synthetic resin material such as polycarbonate or polyethylene and has a thickness of 0.5 to 1.0 mm.

FIG. 3 shows the disc brake cover 40 attached to the disc brake 11. As shown in FIG. 3, the disc brake 11 is accommodated within a wheel 50, and a back side (inner side) of the brake disc 12 is covered by a first inner cover 51 and a second inner cover 52 mounted on the wheel axle 60. At an open end of the disc brake cover 40, the disc portion 41 and the caliper portion 42 have respective end faces 41a and 42a lying flush with each other. At a closed end of the disc brake cover 40, the front surface 42b of the caliper portion 42 is offset from a front surface 41b of the disc portion 41 toward the lateral outward direction of the vehicle body.

FIG. 4 is a cross-sectional view taken along line 4-4 of FIG. 2, with the wheel 50 shown in cross section for clarity. As shown in this figure, the wheel axle 60 is formed integrally with a knuckle 61, and the wheel hub 63 is rotatably mounted on the wheel axle 60 via a bearing 62. The bearing 62 is held in position on the wheel axle 60 by means of a nut 66 with a color 65 disposed between the nut 66 and the bearing 62. Two dust seals 67 and 68 are disposed on opposite sides of the bearing 62 to provide a seal between the wheel axle 60 and the wheel hub 63. The knuckle 61 supports a lower part of the strut 13 to which the brake caliper 14 is mounted.

The wheel studs 21 (only one being shown in FIG. 4) provided on the wheel hub 63 extend successively through through-holes 71 formed in the central boss 17 of the brake disc 12 and through-holes 50b formed in a disc portion 50a of the wheel 50, and lug nuts 70 (only one shown in FIG. 4) are threaded with the wheel studs 21 to thereby attach the wheel 50 to the wheel hub 63.

The brake caliper 14 includes two brake pads 75, 76 of double-layered structure disposed on opposite sides of the brake disc 12, a shim 78 and two spacers 81, 82 disposed on an outer side of each brake pad 75, 76 in the named order when viewed from the brake disc 12. These parts 75, 76, 78, 81, 82 are disposed inside the caliper body 28. The caliper body 28 has a cylinder 84 in which a piston 83 is slidably received. As shown in FIG. 4, the disc portion 41 of the disc brake cover 40 is spaced from the side surface 16a of the brake disc 12 by a predetermined distance C.

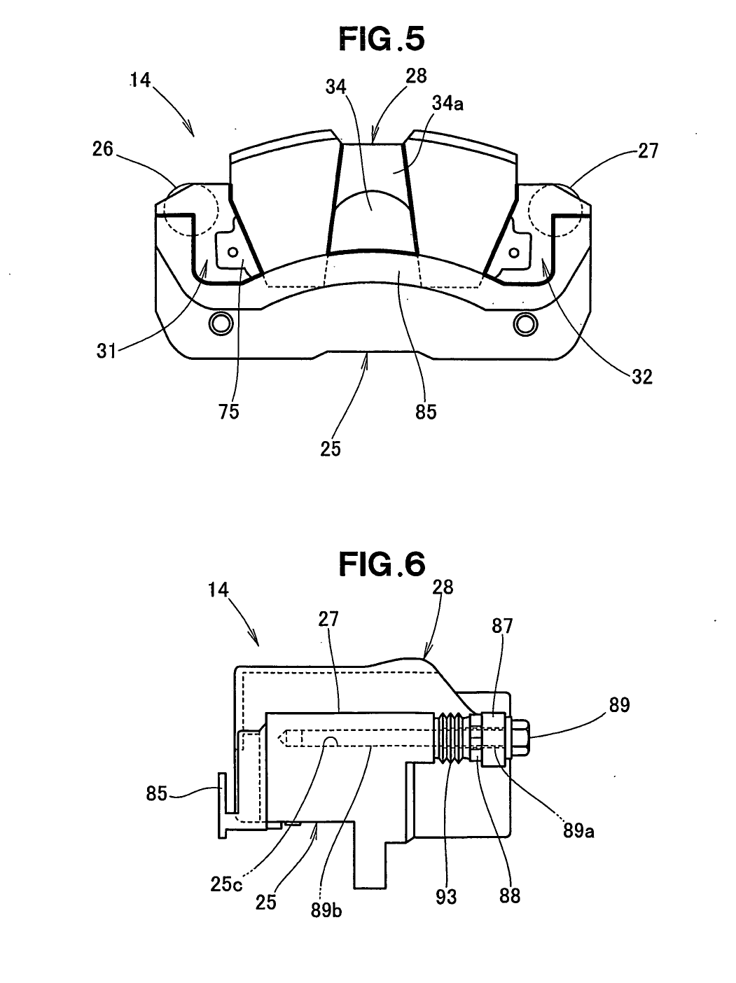

Referring next to FIGS. 5 and 6, the structure of the brake caliper 14 will be described, wherein FIG. 5 is a front elevational view of the brake caliper 14 and FIG. 6 is a right side view of FIG. 5. The brake caliper 14 has an arch-shaped tie bar 85 extending between the support arms 26, 27 and connecting them at one end 26a, 27a located at the front side of the brake caliper 14. The tie bar 85 forms a part of the caliper bracket 25.

As indicated by thick solid lines shown in FIG. 5 for clarity, each of the first recessed portions 31, 32 is defined between the caliper body 28, the tie bar 85 and a respective one of the support arms 26, 27. The second recessed portion 34 is defined between the caliper body 28 and the tie bar 85. The tie bar 85 may be omitted depending on the design of the brake caliper 14 in which instance the first recessed portions 31, 32 are each defined between the caliper bracket 25 and the caliper body 28 at a portion located adjacent to a respective one of the support arms 26, 27, and the second recessed portion 34 is formed in the front surface 34a of the caliper body 28.

As shown in FIG. 6, the support arm 27 has a guide hole 25c extending in a direction parallel to the wheel axle 60 (FIG. 4) for slidably receiving therein a connecting pin 89. The connecting pin 89 comprises a headed pin including a shank having a threaded portion 89a located adjacent to a head (not designated) and a non-threaded portion 89b located remotely from the head and slidably received in the guide hole 25c of the support arm 27. The threaded shank portion 89a extends through an attachment bracket 89 connected to the caliper body 28 and secured to the attachment bracket 89 by means of a nut 88. The guide hole 25c is filled with grease for facilitating smooth sliding movement of the connecting pin 89 relative to the support arm 27. To prevent leakage of the grease, a rubber boot 93 is disposed between the support arm 27 and the nut 93 for sealing the guide hole 25c.

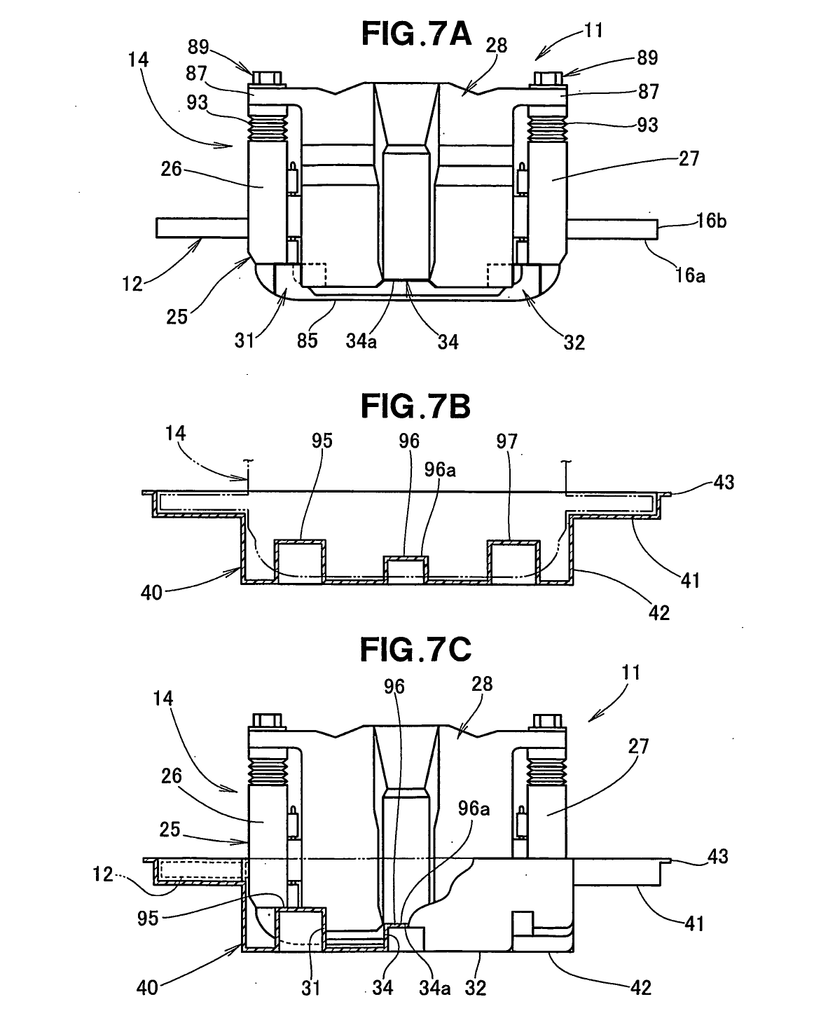

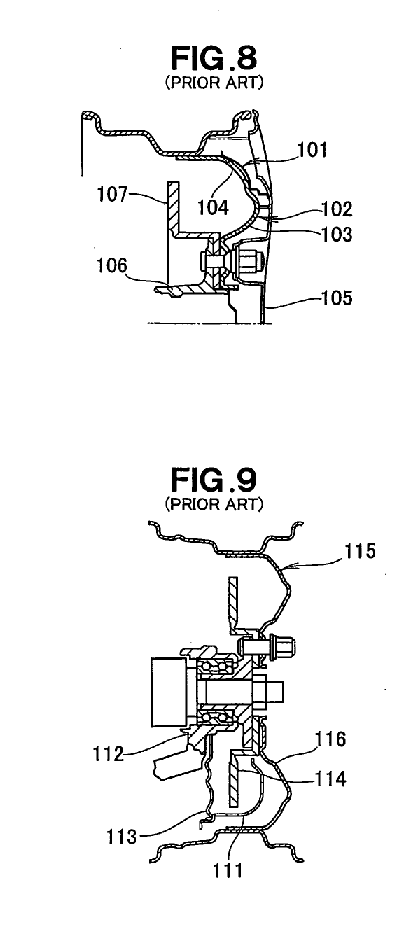

The support arm 26 has the same structure as the support arm 27 and slidably supports a connecting pin 89 (FIG. 7A) in the same manner as described above with respect to the support arm 27. Due to the structural and functional similarity existing between the two support arms 26, 27, further description about the support arm 26 and related parts thereof can be omitted.

Referring next to FIGS. 7A, 7B and 7C, description will be made to a manner in which the disc brake cover 40 is attached to the disc brake 11.

As indicated by thick solid lines shown in FIG. 7A for clarity, the first recessed portions 31, 32 and the second recessed portion 34 are formed in the brake caliper 14 on the front side thereof Each of the first recessed portions 31, 32 is defined between the caliper body 28 and a portion of the caliper bracket 25 including a respective one of the support arms 26, 27 and the die bar 85. The first recessed portion 34 is formed in the front surface 34a of the caliper body 28.

As shown in FIG. 7B, the disc brake cover 40 has on its back side the first protrusions 95, 97 and the second protrusion 96 disposed centrally between the first protrusions 95, 97. The second protrusion 96 has a flat top wall 96a. The first protrusions 95, 97 are configured to fit with the first recessed portions. 31, 32, respectively, of the brake caliper 14, and the second protrusion 96 is configured to fit with the second recessed portion 34. Accordingly, merely by forcing the protrusions 95, 96, 97 into the mating ones of the recessed portions 31, 34, 32, it is readily possible to attach the disc brake cover 40 to the disc brake 11, as shown in FIG. 7C. In an attached state, the disc brake cover 40 covers the brake disc 12 and the brake caliper 14 collectively from a front side of the disc brake 11. More particularly, the disc portion 41 of the brake disc cover 40 is disposed close to the brake disc 12 and covers the side surface 16a (FIG. 7A) and the outer peripheral surface 16b of the brake disc 12. The caliper portion 42 of the disc brake cover 40 covers the brake caliper 14 from the front side thereof.

Since the disc brake cover 40 covers the brake disc 12 and the brake caliper 14 collectively from the front side of the disc brake 11 with the disc portion 41 located close to the brake disc 12, it is possible to effectively prevent rain water from entering into a space or gap between the disc portion 41 and the brake disc 12. Thus, the disc brake cover 40 can offer a sufficient anticorrosion effect to the disc brake 11 during storage or transportation to a final destination of a finished vehicle in which the disc brake 11 is incorporated.

Furthermore, for attachment to the disc brake 11, the disc brake cover 40 requires only one pair of protrusions 95, 97 configured to fit with the first recessed portions 31, 32 of the brake caliper 14. The disc brake cover 40 is, therefore, relatively simple in construction and can be manufactured at a relatively low cost by using an inexpensive molding die.

The top wall 96a of the second protrusion 96 is in abutting engagement with the bottom surface 34a of the second recessed portion 34, as shown in FIG. 7C. Thus, by properly determining a height of the second protrusion 96 (i.e., the position of the top wall 96a), it is possible to keep the disc portion 41 in a desired position which is spaced from the side surface 16a of the brake disc 12 by a predetermined distance C, such as shown in FIG. 4.

After arrival of the finished vehicle to a final destination such as a car dealer, the disc brake cover 40 is removed from the disc brake 11. In this instance, a human operator grips the pull tab 44 (FIG. 2) of the disc brake cover 40 and pulls the pull tab 44 obliquely downward to the right in FIG. 2. This causes the disc brake cover 40 to turn counterclockwise about the wheel axle 60 while the protrusions 95, 96, 97 remain interlocked with the corresponding recessed portions 31, 32, 34 (FIG. 1). Continued pulling of the pull tab 44 causes rupturing of the disc brake cover 40, which begins at the perforated line (weak portion) 46 disposed adjacent to the pull tab 44. The rupturing continues to occur at the perforated lines (weak portions) 46, 47, 48 arranged in succession in the counterclockwise direction in FIG. 2.

The disc brake cover 40 can thus be removed from the disc brake 11 by merely pulling the pull tab 44 in an appropriate direction. In this instance, since the outer peripheral edges of the disc portion 41 and the caliper portion 42 are reinforced by the reinforcement flange 43, the disc brake cover 40 is not separated into small pieces or fragments but keeps a one-piece structure including segments of disc portion 41 and segments of caliper portion 42 connected in series by the reinforcement flange 43. Since the pull tab 44 is located at a position spaced far distant from a point of interlocking engagement between the protrusions 95-97 and the mating recessed portions 31, 34, 32, a pulling force required to remove the brake disc cover 40 from the disc brake 11 against interlocking engagement between the protrusions 95-97 and the recessed portions 31, 34, 32 is relatively small. Thus, the disc brake cover 40 can be removed from the disc brake 11 without requiring undue muscular efforts.

### INDUSTRIAL APPLICABILITY

With the arrangements so far described, the present invention can be used advantageously as a disc brake cover for a disc brake installed in a motor vehicle.

1. A disc brake cover for covering a brake disc and a brake caliper of a disc brake collectively from a front side thereof facing in a lateral outward direction of a vehicle body, the brake caliper having a pair of recessed portions disposed on the front side thereof and defined between a caliper bracket and a caliper body of the brake caliper at portions located adjacent to a pair of support arms of the caliper bracket disposed oil opposite sides of the caliper body and supporting the caliper body so that the caliper body is movable relative to the caliper bracket, the disc brake cover comprising: a disc portion configured to cover a side surface and an outer peripheral surface of the brake disc; a caliper portion integral with the disc portion and configured to cover the brake caliper including the recessed portions thereof, the caliper portion having a pair of protrusions configured to fit with the pair of recessed portions, respectively, of the brake caliper to thereby attach the disc brake cover to the disc brake with the disc portion located close to the brake disc; and a reinforcement flange, extending continuously along an outer peripheral edge of the disc portion and an outer peripheral edge of the caliper portion.

2. The disc brake cover as defined in claim 1, wherein the caliper portion further has a second protrusion disposed centrally between the pair of protrusions and engageable with a front surface of the caliper body to keep the disc portion in a position spaced from the side surface of the brake disc by a predetermined distance.

3. The disc brake cover as defined in claim 2, wherein the brake caliper further has a second recessed portion formed in the front surface of the caliper body and located centrally between the pair of recessed portions, the second protrusion of the caliper portion being configured to fit with the second recessed portion.

4. The disc brake cover as defined in claim 1, wherein each of the disc portion and the caliper portion has a plurality of weak portions arranged in a predetermined pattern to allow the disc brake cover to become fractured when subjected to an external force tending to remove the disc brake cover from the disc brake.

5. The disc brake cover as defined in claim 4, wherein the weak portions are each formed by a perforated fine.

6. The disc brake cover as defined in claim 4, further comprising a pull tab integral with the reinforcement flange and projecting in a radial outward direction from the reinforcing flange for gripping by a human operator.

7. The disc brake cover as defined in claim 6, wherein the pull tab is disposed adjacent to one of the weak portions of at least one of the disc portion and the caliper portion.

8. The disc brake cover as defined in claim 6, wherein the pull tab is located at a position spaced far distant from the protrusions.

9. The disc brake cover as defined in claim 2, wherein each of the disc portion and the caliper portion has a plurality of weak portions arranged in a predetermined pattern to allow the disc brake cover to become fractured when subjected to an external force tending to remove the disc brake cover from the disc brake.

10. The disc brake cover as defined in claim 3, wherein each of the disc portion and the caliper portion has a plurality of weak portions arranged in a predetermined pattern to allow the disc brake cover to become fractured when subjected to an external force tending to remove the disc brake cover from the disc brake.

11. The disc brake cover as defined in claim 5, further comprising a pull tab integral with the reinforcement flange and projecting in a radial outward direction from the reinforcing flange for gripping by a human operator.

12. The disc brake cover as defined in claim 7, wherein the pull tab is located at a position spaced far distant from the protrusions.
